(19) United States
(12) Patent Application Publication
(10) Pub. No.: US 2015/0139457 A1
(43) Pub. Date: May 21, 2015

(54) SPEAKER DEVICE AND ELECTRONIC DEVICE

(71) Applicant: NEC CASIO Mobile Communications, Ltd., Kanagawa (JP)

(72) Inventors: Yasuharu Onishi, Kanagawa (JP); Jun Kuroda, Kanagawa (JP); Yuichiro Kishinami, Kanagawa (JP); Motoyoshi Komoda, Kanagawa (JP)

(21) Appl. No.: 14/406,234

(22) PCT Filed: Dec. 26, 2012
(86) PCT No.: PCT/JP2012/008315

§ 371 Date: Dec. 8, 2014

(30) Foreign Application Priority Data
Jun. 6, 2012 (JP) 2012-128813

(51) Int. Cl. H04R 17/00

(52) U.S. Cl. CPC H04R 17/00
USPC 381/190

(57) ABSTRACT

A speaker device (100) includes a circuit board (10), a piezoelectric element (20), a spacer (30) which is disposed between the piezoelectric element (20) and the circuit board (10), and an air chamber (40). The spacer (30) fixes the piezoelectric element (20) to the circuit board (10) so that an internal space (31) is formed between the piezoelectric element (20) and the circuit board (10). The internal space (31) and the air chamber (40) communicate with each other. For example, the internal space (31) and the air chamber (40) communicate with each other through only an air medium.

### TECHNICAL FIELD

The present invention relates to a speaker device and an electronic device.

### BACKGROUND ART

In recent years, as typified by mobile phones, various small electronic devices having an acoustic function (a music playback function, a hands-free call function, and the like) have been developed. With respect to these electronic devices, there has always been a strong need for a further decrease in the size and thickness thereof.

With respect to a speaker device having an acoustic function, there has also been a need for a high sound quality in addition to a need for a decrease in the size and thickness thereof. In such situations, the development of a piezoelectric thin speaker device substituted for an electrodynamic speaker device has been actively conducted.

Patent Documents 1 and 2 disclose that a piezoelectric element constituting a speaker is fixed to a case and a liquid crystal display module through a spacer. Further, Patent Documents 1 and 2 disclose that an internal space of the spacer communicates with a sound guide path.

Patent Document 3 discloses a piezoelectric speaker in which a piezoelectric element is provided in a front plate and the front plate is connected to a back plate through a spacer.

Patent Document 4 discloses that a piezoelectric element is provided in a plate-shaped insulating cover through a spacer so that a first air chamber is formed between the piezoelectric element and the insulating cover and that a second air chamber is provided on a surface of the insulating cover on the opposite side of the first air chamber. A braking hole formed in the insulating cover is disposed between the first air chamber and the second air chamber. The technique of Patent Document 4 relates to the vibration damping of the speaker. A block-shaped braking body formed of expandable plastic or a braking film such as a nonwoven fabric cloth or a plastic mesh cloth is disposed between the first air chamber and the second air chamber, and the first air chamber and the second air chamber do not directly communicate with each other.

Patent Document 5 discloses that a piezoelectric diaphragm constituting a microphone is fixed to a printed circuit through a spacer. An internal space of the spacer is divided into two spaces by a wall located between the piezoelectric diaphragm and the printed circuit, and the spaces communicate with each other through a hole formed in the wall.

### RELATED DOCUMENT

### Patent Document

[Patent Document 1] Japanese Unexamined Patent Publication No. 2007-124634

[Patent Document 2] Japanese Unexamined Patent Publication No. 2008-079180

[Patent Document 3] Japanese Unexamined Patent Publication No. 11-113093

[Patent Document 4] Japanese Unexamined Utility Model Registration Publication No. 63-090395

[Patent Document 5] Japanese Unexamined Patent Publication No. 59-174097

### DISCLOSURE OF THE INVENTION

A piezoelectric speaker device reproduces sound waves using expansion and contraction movements of a piezoelectric element. For this reason, there is an advantage of having a decrease in the thickness thereof as compared to an electrodynamic speaker device constituted by a magnet or a voice coil. In addition, since the piezoelectric element itself doubles as a driving source and a vibrating surface, there is also an advantage of being able to emit sound waves from both faces thereof in an amplitude direction.

However, the piezoelectric element is likely to be influenced by a sound factor such as inertance due to an air load. For this reason, when a piezoelectric speaker device is mounted on a small electronic device such as a thin mobile phone having a mounting space restriction, there are several problems in order to realize satisfactory acoustic characteristics.

A first problem is a reduction in a sound pressure level due to a shortage of rear capacity. In a small electronic device such as a thin mobile phone, a clearance between a piezoelectric element and a substrate located on the rear surface of the piezoelectric element is narrowed. For this reason, the piezoelectric element is subjected to a load of acoustic resistance, and thus a sound pressure level is remarkably attenuated.

A second problem is a reduction in sound pressure level due to interference of sound waves. In a case of a piezoelectric element, sound waves are emitted from both front and back faces. Here, a positive-phase sound wave is emitted from the front face, while a reverse phase sound wave of which the phase is inverted with respect to the positive phase is emitted from the back face. For this reason, sound waves emitted from both faces of the piezoelectric element interfere with each other, and thus a sound pressure level is attenuated.

An object of the present invention is to provide a piezoelectric speaker device and an electronic device which are capable of easily improving a sound pressure level.

The present invention provides a speaker device including a circuit board; a piezoelectric element which emits sound waves by vibration; a spacer which is disposed between the piezoelectric element and the circuit board and fixes the piezoelectric element to the circuit board so that an internal space is formed between the piezoelectric element and the circuit board; and an air chamber which is provided separately from the internal space. The internal space and the air chamber communicate with each other.

In addition, the present invention provides an electronic device including a speaker device. The speaker device includes a circuit board, a piezoelectric element which emits sound waves by vibration, a spacer which is disposed between the piezoelectric element and the circuit board and fixes the piezoelectric element to the circuit board so that an internal space is formed between the piezoelectric element and the circuit board, and an air chamber which is provided separately from the internal space. The internal space and the air chamber communicate with each other.

According to the present invention, it is possible to easily improve a sound pressure level.

### BRIEF DESCRIPTION OF THE DRAWINGS

The above-described objects, other objects, features and advantages will be further apparent from the preferred embodiments described below, and the accompanying drawings as follows.

FIG. 1 is a schematic diagram of a speaker device according to a first embodiment.

FIG. 2 is a schematic cross-sectional view of an oscillator of the speaker device.

FIG. 3 is a schematic cross-sectional view showing a layered structure of a piezoelectric element.

FIG. 4 is a schematic cross-sectional view showing another example of the speaker device according to the first embodiment.

FIG. 5 is a schematic cross-sectional view of an electronic device according to the first embodiment.

FIG. 6 is a schematic cross-sectional view of a speaker device according to a second embodiment.

FIG. 7 is a schematic cross-sectional view of an electronic device according to the second embodiment.

FIG. 8 is a schematic cross-sectional view of an electronic device including a speaker device according to a comparative example.

FIG. 9 is a diagram showing sound output characteristics in the first embodiment, the second embodiment, and the comparative example.

### DESCRIPTION OF EMBODIMENTS

Hereinafter, embodiments of the invention will be described with reference to the accompanying drawings. In addition, in all the drawings, same reference numerals denote same components, and a description thereof will not be repeated.

### First Embodiment

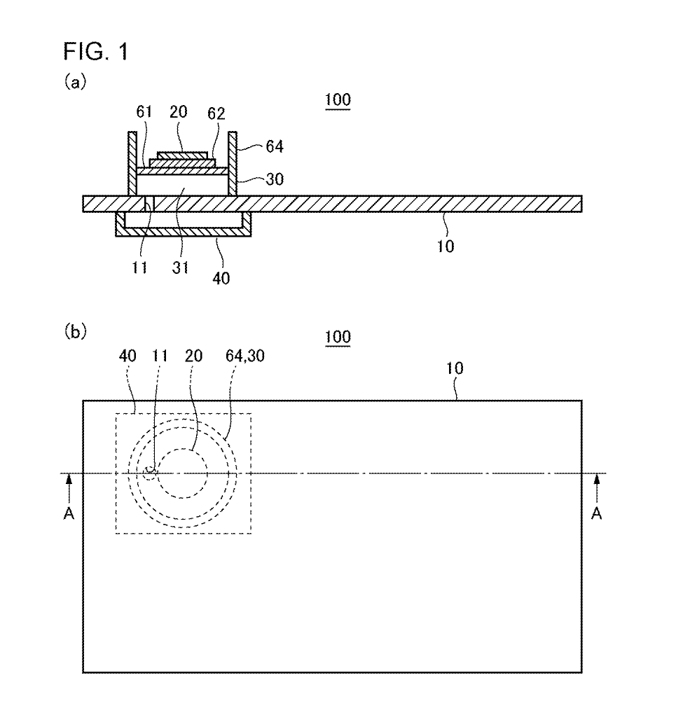

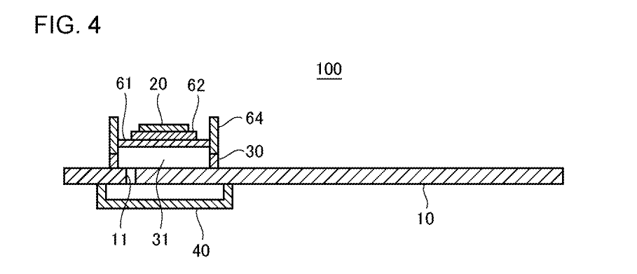

FIG. 1 is a schematic diagram of a speaker device 100 according to a first embodiment. In FIG. 1, FIG. 1(b) is a plan view, and FIG. 1(a) is a cross-sectional view taken along line A-A of FIG. 1(b). FIG. 4 is a schematic cross-sectional view showing another example of the speaker device 100 according to the first embodiment.

As shown in FIG. 1, the speaker device 100 according to this embodiment includes a circuit board 10, a piezoelectric element 20 which emits sound waves by vibration, a spacer 30 which is disposed between the piezoelectric element 20 and the circuit board 10, and an air chamber 40. The spacer 30 fixes the piezoelectric element 20 to the circuit board 10 so that an internal space 31 of the spacer 30 is formed between the piezoelectric element 20 and the circuit board 10. In other words, the piezoelectric element 20 is fixed to the circuit board 10 through the spacer 30 so that the internal space 31 is formed between the piezoelectric element 20 and the circuit board 10. The air chamber 40 is provided separately from the internal space 31. The internal space 31 and the air chamber 40 communicate with each other.

A space obtained by combining the internal space 31 and the air chamber 40 functions as a rear air space of the piezoelectric element 20. That is, the air chamber 40 is added to the internal space 31, thereby constituting the rear air space. For this reason, it is possible to sufficiently secure the capacity of the rear air space. In addition, a location at which the air chamber 40 is disposed can be set independently of locations at which the piezoelectric element 20 and the spacer 30 are disposed, and thus a layout restriction of the air chamber 40 is lax.

The space obtained by combining the internal space 31 and the air chamber 40, that is, the rear air space, is configured as a closed space. For this reason, sound waves emitted from the back face side of the piezoelectric element 20 are confined in the space. In other words, it is possible to suppress the sound leakage of the sound waves emitted from the back face side of the piezoelectric element 20. For this reason, it is possible to suppress interference between the sound waves emitted from the back face side of the piezoelectric element 20 and the sound waves emitted from the front side of the piezoelectric element 20.

For example, the space within the air chamber 40 is larger than the internal space 31. In this manner, it is possible to sufficiently secure acoustic capacitance in the rear air space and to achieve an improvement in sound quality.

In this embodiment, the air chamber 40 is disposed on the opposite side of the piezoelectric element 20 and the spacer 30 with the circuit board 10 interposed between the air chamber 40, and the piezoelectric element 20 and the spacer 30. The internal space 31 and the air chamber 40 communicate with each other through a through hole 11 formed in the circuit board 10. In other words, this embodiment is configured such that sound waves emitted from the back face side of the piezoelectric element 20 are shielded by the circuit board 10, the spacer 30, and the air chamber 40.

Here, the internal space 31 of the spacer 30 and the air chamber 40 communicate with each other through only an air medium. In other words, a substantial member such as the braking body and the braking film, which are disclosed in Patent Document 4, is not present inside the through hole 11 or in a region facing the through hole 11, and the internal space 31 and the air chamber 40 directly communicate with each other.

For example, the spacer 30 is formed in a tubular shape. More specifically, for example, the spacer 30 has a tubular shape in which the length in an axial direction is shorter than the outer diameter thereof.

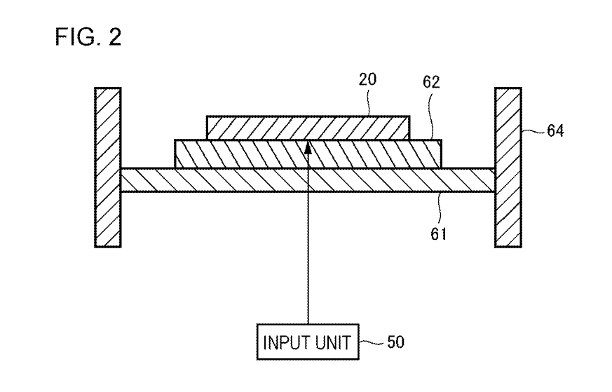

FIG. 2 is a schematic cross-sectional view of an oscillator of the speaker device 100.

For example, the oscillator includes a sheet-shaped vibration member 61, a sheet-shaped elastic member 62, the piezoelectric element 20, and a supporting member 64.

The vibration member 61 is constituted by, for example, a resin film. The elastic member 62 is attached to one surface of the vibration member 61. The piezoelectric element 20 is attached to a surface of the elastic member 62 on the opposite side of the vibration member 61 side.

The supporting member 64 supports an edge of the vibration member 61. Meanwhile, the supporting member 64 may be integrally formed with the spacer 30 described above (formed as a portion of the spacer 30) as shown in FIG. 1(a), or may be formed separately from the spacer 30 and supported by the spacer 30 as shown in FIG. 4.

The elastic member 62 vibrates by the vibration generated from the piezoelectric element 20, and oscillates a sound wave having a frequency of, for example, equal to or higher than 20 kHz. The piezoelectric element 20 also oscillates a sound wave having a frequency of, for example, equal to or higher than 20 kHz by the element itself vibrating. The vibration member 61 also vibrates by the vibration generated from the piezoelectric element 20, and oscillates a sound wave having a frequency of, for example, equal to or higher than 20 kHz.

The elastic member 62 adjusts a fundamental resonance frequency of the piezoelectric element 20. The fundamental resonance frequency of the mechanical vibrator depends on a load weight and compliance. Since the compliance is the machine stiffness of a vibrator, it is possible to control the fundamental resonance frequency of the piezoelectric element 20 by controlling the stiffness of the elastic member 62. It is preferable that the thickness of the elastic member 62 be equal to or greater than 5 μm and equal to or less than 500 μm. It is preferable that the elastic member 62 have a longitudinal elastic modulus, which is an index indicating stiffness, of equal to or greater than 1 Gpa and equal to or less than 500 GPa. The material constituting the elastic member 62 is not particularly limited as long as it is a material, such as a metal or a resin, having a high elastic modulus with respect to the piezoelectric element 20 which is formed of a brittle material, but is preferably phosphor bronze, stainless steel or the like from the viewpoint of workability or costs.

The planar shape of the piezoelectric element 20 is, for example, a circular shape. However, the planar shape of the piezoelectric element 20 is not limited to the circular shape. The piezoelectric element 20 is configured such that the entirety of the surface facing the elastic member 62 is fixed to the elastic member 62 by an adhesive. Thus, the entirety of one surface of the piezoelectric element 20 is constrained by the elastic member 62.

An input unit 50 oscillates ultrasonic waves from the piezoelectric element 20 by inputting a modulating signal for a parametric speaker to the piezoelectric element 20. A transportation wave of the modulating signal is an ultrasonic wave having a frequency of, for example, equal to or higher than 20 kHz, and specifically, is an ultrasonic wave having a frequency of, for example, 100 kHz. The input unit 50 controls the piezoelectric element 20 so as to have a predetermined oscillation output.

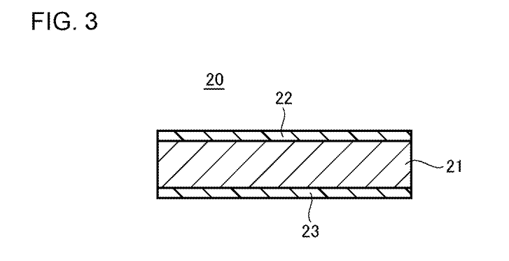

FIG. 3 is a cross-sectional view showing a layered structure of the piezoelectric element 20 in a thickness direction. The piezoelectric element 20 includes a piezoelectric body 21, an upper-surface electrode 22, and a lower-surface electrode 23.

The piezoelectric body 21 is polarized in the thickness direction. The material constituting the piezoelectric body 21 may be any of an inorganic material and an organic material as long as it is a material having a piezoelectric effect. However, the material constituting the piezoelectric body 21 is preferably a material having a high electro-mechanical conversion efficiency, for example, piezoelectric zirconate titanate (PZT) or barium titanate (BaTiO₃). The thickness of the piezoelectric body 21 is, for example, equal to or greater than 10 μm and equal to or less than 1 mm.

Although the materials constituting the upper-surface electrode 22 and the lower-surface electrode 23 are not particularly limited, for example, silver or silver/palladium can be used. Since silver is used as a low-resistance versatile electrode material, there is an advantage in a manufacturing process or costs and the like. Since silver/palladium is a low-resistance material excellent in oxidation resistance, there is an advantage from the viewpoint of reliability. In addition, the thickness of the upper-surface electrode 22 and the lower-surface electrode 23 is not particularly limited, but the thickness is preferably equal to or greater than 1 μm and equal to or less than 50 μm.

The input unit 50 inputs a modulating signal for a parametric speaker to the upper-surface electrode 22 and the lower-surface electrode 23.

The parametric speaker emits ultrasonic waves (transportation waves) on which an AM modulation, a DSB modulation, an SSB modulation, or an FM modulation is performed from each of a plurality of oscillation sources into the air, and issues an audible sound based on the non-linear characteristics when ultrasonic waves are propagated in the air. The term “non-linear” herein indicates a transition from a laminar flow to a turbulent flow when the Reynolds number expressed by the ratio of the inertial action and the viscous action of a flow increases. Since the sound wave is very slightly disturbed within a fluid, the sound wave is propagated non-linearly. Particularly, in the ultrasonic wave frequency band, the non-linearity of the sound wave can be easily observed. When the ultrasonic waves are emitted into the air, higher harmonic waves associated with the non-linearity of the sound wave are conspicuously generated. In addition, the sound wave is in a sparse and dense state in which a difference in the molecular density occurs in the air. When it takes time for air molecules to be restored rather than compressed, the air which is not capable of being restored after the compression collides with air molecules continuously propagated, and thus a shock wave occurs. The audible sound is generated by this shock wave.

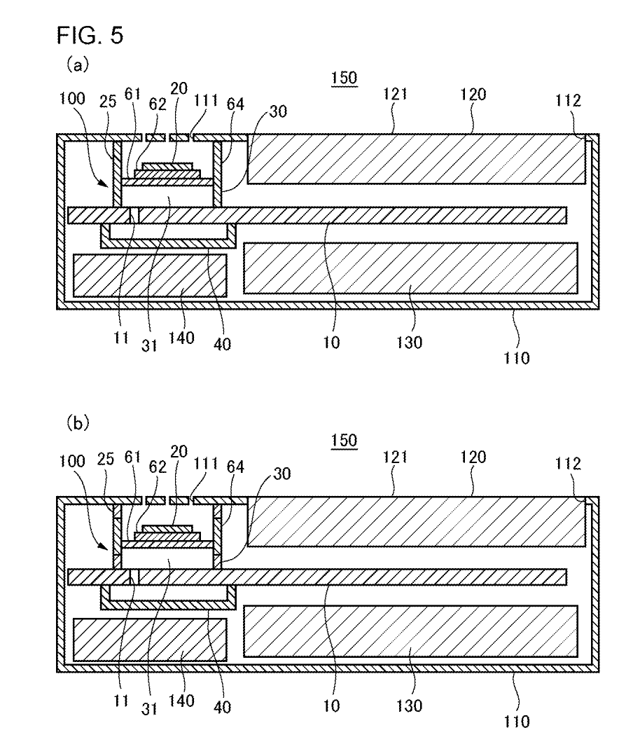

FIG. 5(a) and FIG. 5(b) are schematic cross-sectional views of an electronic device 150 according to the first embodiment.

As shown in FIG. 5, the electronic device 150 includes the speaker device 100. The electronic device 150 is, for example, a mobile phone or any of other small portable terminal devices. The electronic device 150 includes, for example, a housing 110, a liquid crystal display 120, a secondary battery 130, and a camera 140 in addition to the speaker device 100. The speaker device 100, the liquid crystal display 120, the secondary battery 130, and the camera 140 are provided within the housing 110. In addition to the input unit 50 (FIG. 2) which is a circuit for driving the piezoelectric element 20, a circuit for operation control of the liquid crystal display 120, a circuit for operation control of the camera 140, and the like are provided on the circuit board 10.

The housing 110 has, for example, a flat box shape. An opening 112 exposing a display screen 121 of the liquid crystal display 120 to the outer surface of the electronic device 150 is formed in one surface of the housing 110. Further, a sound hole 111 facing a surface on the front side of the piezoelectric element 20 is formed in one surface of the housing 110 (surface in which the opening 112 is formed). Thus, it is possible to output a sound from the surface on which the display screen 121 is formed. In this case, the liquid crystal display 120 and the piezoelectric element 20 are disposed on the same side based on the circuit board 10.

A sound guide wall 25 guiding a sound wave, which is oscillated from the piezoelectric element 20 and the like, to the sound hole 111 is provided between the supporting member 64 and the inner surface of the housing 110. Meanwhile, the sound guide wall 25 may be integrally formed with the spacer 30 described above (formed as a portion of the spacer 30) as shown in FIG. 5 (a). Alternatively, the sound guide wall 25 may be formed separately from the spacer 30 and supported by the spacer 30 (for example, supported by the spacer 30 through the supporting member 64) as shown in FIG. 5 (b).

Here, in recent years, there has been a tendency for an area of the display screen 121 of a small portable terminal device to be enlarged, and thus an arrangement space of the piezoelectric element 20 has been restricted. In particular, it is becoming difficult to secure a space of the rear air space of the piezoelectric element 20.

Based on such situations, in this embodiment, the through hole 11 is formed in the circuit board 10, and the air chamber 40 is disposed on the back face side of the circuit board 10. Thus, it is possible to form a rear air space (more specifically, enlarging the rear air space) by using the space on the back face side of the circuit board 10.

According to the first embodiment described above, in the speaker device 100, the piezoelectric element 20 is fixed to the circuit board 10 through the spacer 30, and the internal space 31 is formed between the piezoelectric element 20 and the circuit board 10. Further, the speaker device 100 includes the air chamber 40 which is provided separately from the internal space 31, and the internal space 31 and the air chamber 40 communicate with each other. Thus, it is possible to sufficiently secure the capacity of an acoustic space on the rear side of the piezoelectric element 20, that is, the rear air space, and to achieve an improvement in sound quality. Here, since the air chamber 40 is disposed independently of the spacer 30, a layout restriction of the air chamber 40 is lax. For this reason, it is possible to realize more satisfactory acoustic characteristics while reducing a mounting restriction of the speaker device 100 as much as possible.

In addition, a space obtained by combining the internal space 31 and the air chamber 40 is configured as a closed space. Thus, it is possible to suppress the sound leakage of sound waves emitted from the back face side of the piezoelectric element 20, and to suppress interference between sound waves emitted from the back face side of the piezoelectric element 20 and sound waves emitted from the front side of the piezoelectric element 20.

In addition, the air chamber 40 is disposed on the opposite side of the piezoelectric element 20 and the spacer 30 with the circuit board 10 interposed between the air chamber 40, and the piezoelectric element 20 and the spacer 30, and the internal space 31 of the spacer 30 and the air chamber 40 communicate with each other through the through hole 11 formed in the circuit board 10. Accordingly, it is possible to loosen a layout restriction of a space on the same side as the piezoelectric element 20 based on the circuit board 10, and to effectively use a space on the opposite side of the piezoelectric element 20 based on the circuit board 10.

In addition, the air chamber 40 is larger than the space of the spacer 30, and thus it is possible to sufficiently secure the capacity of the rear air space and to achieve an improvement in sound quality.

### Second Embodiment

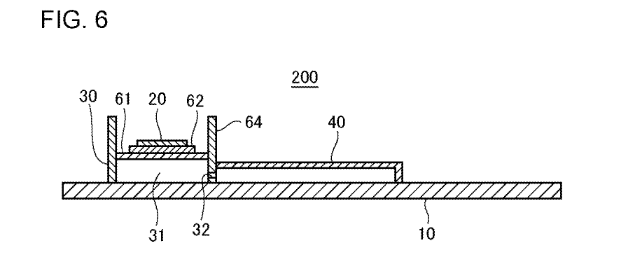

FIG. 6 is a schematic cross-sectional view of a speaker device 200 according to a second embodiment. The speaker device 200 according to this embodiment is different from the speaker device 100 according to the first embodiment described above only in the following points, and is configured in the same manner as the speaker device 100 in other respects.

In this embodiment, a piezoelectric element 20, a spacer 30, and an air chamber 40 are disposed on the same surface of a circuit board 10.

More specifically, for example, the air chamber 40 and the spacer 30 are disposed adjacent to each other. An internal space 31 and the air chamber 40 communicate with each other through a through hole 32 formed in the spacer 30.

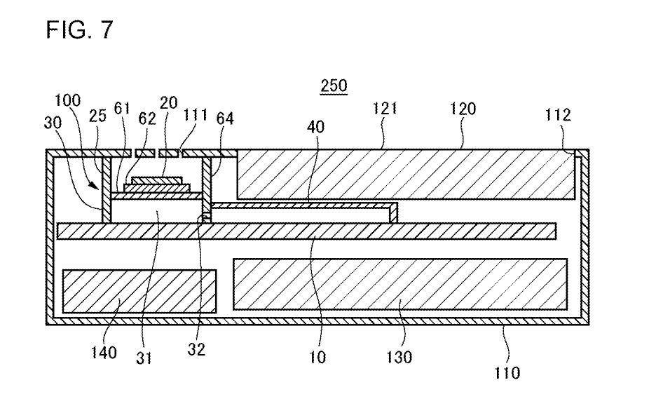

FIG. 7 is a schematic cross-sectional view of an electronic device 250 according to the second embodiment. The electronic device 250 according to this embodiment is different from the electronic device 150 according to the first embodiment described above only in that the speaker device 200 is provided instead of the speaker device 100, and is configured in the same manner as the electronic device 150 in other respects.

Meanwhile, in order to achieve the efficiency of a space within a housing 110, the air chamber 40 is preferably disposed between a liquid crystal display 120 and the circuit board 10.

According to the second embodiment described above, the same effects as in the first embodiment are obtained.

Here, sound output characteristics of the electronic device 150 according to the first embodiment described above, the electronic device 250 according to the second embodiment described above, and an electronic device 350 according to a comparative example will be described.

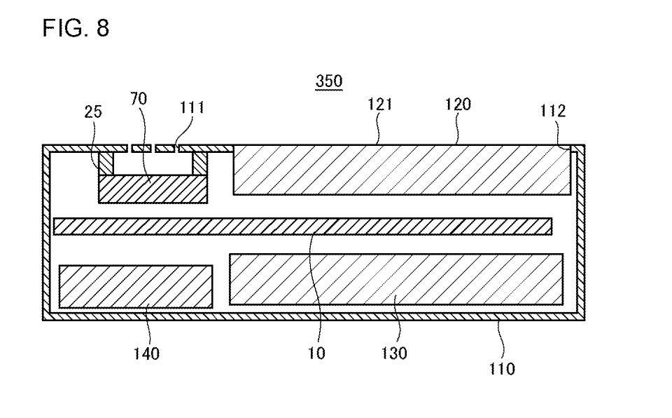

As shown in FIG. 8, the electronic device 350 according to the comparative example is different from the electronic device 150 according to the first embodiment only in that an electrodynamic speaker 70 is provided instead of the above-described oscillator (FIG. 2), and is configured in the same manner as the electronic device 150 in other respects.

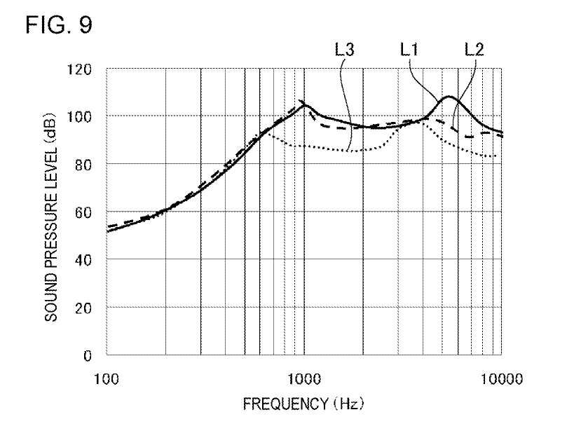

FIG. 9 is a diagram showing sound output characteristics in the electronic devices 150, 250, and 350. A horizontal axis represents a frequency (unit: Hz), and a vertical axis represents a sound pressure level (unit: dB). As shown in FIG. 9, according to the electronic devices 150 and 250 of the first and second embodiments, it is possible to realize a high sound pressure level in an audible sound range, as compared with the electronic device 350 according to the comparative example.

The application is based on Japanese Patent Application No. 2012-128813 filed on Jun. 6, 2012, the content of which is incorporated herein by reference.

1. A speaker device comprising:
a circuit board;
a piezoelectric element which emits sound waves by vibration;
a spacer which is disposed between the piezoelectric element and the circuit board and fixes the piezoelectric element to the circuit board so that an internal space is formed between the piezoelectric element and the circuit board; and
an air chamber which is provided separately from the internal space,
wherein the internal space and the air chamber communicate with each other.

2. The speaker device according to claim 1, wherein the internal space and the air chamber communicate with each other through only an air medium.

3. The speaker device according to claim 1, wherein a space obtained by combining the internal space and the air chamber is configured as a closed space.

4. The speaker device according to claim 1,
wherein the air chamber is disposed on an opposite side of the piezoelectric element and the spacer with the circuit board interposed between the air chamber, and the piezoelectric element and the spacer, and
wherein the internal space and the air chamber communicate with each other through a through hole formed in the circuit board.

5. The speaker device according to claim 1, wherein the air chamber and the spacer are disposed on the same surface of the circuit board.

6. The speaker device according to claim 5, wherein the air chamber and the spacer are disposed adjacent to each other, and the internal space and the air chamber communicate with each other through a through hole formed in the spacer.

7. The speaker device according to claim 1, wherein the air chamber is larger than the internal space.

8. An electronic device comprising:
a speaker device,
wherein the speaker device includes
a circuit board,
a piezoelectric element which emits sound waves by vibration,
a spacer which is disposed between the piezoelectric element and the circuit board and fixes the piezoelectric element to the circuit board so that an internal space is formed between the piezoelectric element and the circuit board, and
an air chamber which is provided separately from the internal space, and
wherein the internal space and the air chamber communicate with each other.

9. The electronic device according to claim 8, wherein the internal space and the air chamber communicate with each other through only an air medium.

10. The electronic device according to claim 8, wherein a space obtained by combining the internal space and the air chamber is configured as a closed space.

11. The speaker device according to claim 2, wherein a space obtained by combining the internal space and the air chamber is configured as a closed space.

12. The speaker device according to claim 2, wherein the air chamber is disposed on an opposite side of the piezoelectric element and the spacer with the circuit board interposed between the air chamber, and the piezoelectric element and the spacer, and wherein the internal space and the air chamber communicate with each other through a through hole formed in the circuit board.

13. The speaker device according to claim 3, wherein the air chamber is disposed on an opposite side of the piezoelectric element and the spacer with the circuit board interposed between the air chamber, and the piezoelectric element and the spacer, and wherein the internal space and the air chamber communicate with each other through a through hole formed in the circuit board.

14. The speaker device according to claim 2, wherein the air chamber and the spacer are disposed on the same surface of the circuit board.

15. The speaker device according to claim 3, wherein the air chamber and the spacer are disposed on the same surface of the circuit board.

16. The speaker device according to claim 2, wherein the air chamber is larger than the internal space.

17. The speaker device according to claim 3, wherein the air chamber is larger than the internal space.

18. The speaker device according to claim 4, wherein the air chamber is larger than the internal space.

19. The speaker device according to claim 5, wherein the air chamber is larger than the internal space.

20. The speaker device according to claim 6, wherein the air chamber is larger than the internal space.
